(19) United States
(12) Patent Application Publication
(10) Pub. No.: US 2024/0163671 A1
(43) Pub. Date: May 16, 2024

(54) V-EASDF AND IPUPS

(71) Applicant: Nokia Technologies Oy, Espoo (FI)

(72) Inventors: Klaus HOFFMANN, Munich (DE); Laurent THIEBAUT, Massy (FR); Shubhranshu SINGH, Munich (DE); Bruno LANDAIS, Lannion (FR)

(21) Appl. No.: 18/504,514

(22) Filed: Nov. 8, 2023

(30) Foreign Application Priority Data
Nov. 10, 2022 (GB) 2216802.5

(51) Int. Cl. H04W 12/08; H04W 8/02; H04W 12/033

(52) U.S. Cl. CPC H04W 12/08; H04W 8/02; H04W 12/033

(57) ABSTRACT

A method, for use in a network control element, is provide, the method comprising: allocating a network security function between a visited network and a home network of a user equipment, and controlling domain name system related signalling between an edge computing related network element in the visited network and a network element in the home network such that the domain name system related signalling is subjected to the network security function.

### FIELD OF THE INVENTION

The present invention relates to an apparatus, a method and a computer program product for providing security in a roaming scenario in edge computing.

### RELATED BACKGROUND ART

The following meanings for the abbreviations used in this specification apply:
AF Application Function
AUSF Authentication Server Function
DN Data Network
DNN Data Network Name
DNS Domain Name System
EAS Edge Application Server
EASDF Edge Application Server Discovery Function
FQTEID Fully Qualified Tunnel Endpoint ID
GPRS General Packet Radio Service
GRE Generic Routing Encapsulation
GTP GPRS Tunnelling Protocol
H-PLMN Home Public Land Network
H-SMF Home Session Management Function
HR Home Routed
ID Identifier
IPUPS Inter PLMN User Plane Security
LBO Local Break Out
NEF Network Exposure Function
NF Network Function
NRF Network Repository Function
NSACF Network Slice Admission Control Function
NSSAAF Network Slice-specific and SNPN Authentication and Authorization Function
NSSF Network Slice Selection Function
PCF Policy Control Function
PDN Packet Data Network
PDU Protocol Data Unit
PLMN Public Land Mobile Network
PSA PDU Session Anchor
RAN Radio Access Network
SEPP Security Edge Protection Proxy
SMF Session Management Function
SNPN Stand-alone Non-Public Network
TEID Tunnel Endpoint ID
UE User Equipment
UL Uplink
UL CL Uplink Classifier
UL CL UPF uplink classifier UPF
UPF User Plane Function
URLLC Ultra Reliable Low Latency Communication
V-EASDF Visited EASDF
V-PLMN Visited PLMN
V-SMF Visited Session Management Function
V-UPF Visited User Plane Function

Example embodiments, although not limited to this, relate to Edge Computing (EC), in scenarios where home-routed (HR) roaming is performed. In particular, an issue of TR 23700-48 “5G System Enhancements for Edge Computing; Phase 2 (Release 18)” is how an EAS connected to the V-PLMN can be determined even in case of home routed roaming. Solutions exist where direct connectivity between V-EASDF and H-EADSF/DNS server are suggested. However, this connectivity model raises security concerns and needs to be remedied.

FIG. 6 (reflecting FIG. 4.2.4-9 of TS 23.501) shows a roaming 5G system architecture—home routed scenario in service based interface representation.

As described in TS 23.501, operators can deploy UPFs supporting the Inter PLMN UP Security (IPUPS) functionality at the border of their network to protect their network from invalid inter PLMN N9 traffic in home routed roaming scenarios. The UPFs supporting the IPUPS functionality in VPLMN and HPLMN are controlled by the V-SMF and the H-SMF of that PDU Session respectively. A UPF supporting the IPUPS functionality terminates GTP-U N9 tunnels. The SMF can activate the IPUPS functionality together with other UP functionality in the same UPF, or insert a separate UPF for the IPUPS functionality in the UP path (which e.g. may be dedicated to be used for IPUPS functionality). FIG. 5 depicts the home routed roaming architecture where a UPF is inserted in the UP path for the IPUPS functionality.

The IPUPS functionality is specified in clause 5.8.2.14 of TS 23.501. Operators can deploy UPF(s) supporting the Inter PLMN User Plane Security (IPUPS) functionality at the border of their network to protect their networks from invalid inter PLMN N9 traffic. The IPUPS functionality forwards GTP-U packets (received via the N9 interface) only if they belong to an active PDU Session and are not malformed, as described in TS 33.501. The SMF can activate the IPUPS functionality together with other UP functionality in the same UPF, or insert a separate UPF in the UP path for the IPUPS functionality. In both cases the UPF with IPUPS functionality is controlled by the SMF via the N4 interface.

Thus, as mentioned above, in HR roaming, one can install at the network border (between V-PLMN and H-PLMN) on the user plane, i.e. on both, the “last” V-UPF in the V-PLMN and the “first” H-UPF in the H-PLMN, a security functionality, the IPUPS (Inter PLMN User Plane Security).

Before EC was specified also for HR roaming, that means in “normal” HR roaming scenarios (without any EC being performed), all user data would go through this V-UPF/H-UPF connection and IPUPS would thus be deployed to all user data. However, the concept for EC in HR roaming (now defined in TR 23.700-48) envisages that particularly the DNS messages sent during the EAS (edge application server) selection procedure would go from V-EASDF (EAS discovery function) directly to the H-DNS or H-EASDF. I.e. these DNS messages will not traverse the normal V-UPF/H-UPF connection and therefore also not go through the IPUPS functionality.

In other words, with the current concept for EC in HR roaming scenarios, user plane messages (i.e. the DNS messages) would traverse the PLMN border without being subject to IPUPS. This raises some security concerns.

### SUMMARY OF THE INVENTION

Example embodiments address this situation and aim to provide a procedure/architecture enhancement where also these DNS messages will traverse the IPUPS functionality.

This is achieved by the methods, apparatuses and non-transitory computer-readable storage media as specified by the appended claims.

According to some example embodiments, a network security function is allocated between a visited network and a home network of a user equipment, and domain name system related signalling between an edge computing related network element in the visited network and a network element in the home network is controlled such that the domain name system related signalling is subjected to the network security function.

According to some example embodiments, in a network element, domain name system related signalling is received from an edge computing related network element in a visited network, a security check is performed on the domain name system related signalling, and the domain name system related signalling is forwarded towards a network element in the home network, in case the security check is positive.

According to some example embodiments, in an edge computing related network element, handling domain name system signalling from an user equipment's data session in a visited network of the user equipment is handled; corresponding domain name system related signalling is sent towards a network element in the home network, in a sending tunnel dedicated to the user equipment's data session; receiving domain name system related signalling initiated by a network element in the home network is received in a receiving tunnel dedicated to the User equipment's data session, and received domain name system related signalling is sent to a user equipment's data session.

### BRIEF DESCRIPTION OF THE DRAWINGS

These and other objects, features, details and advantages will become more fully apparent from the following detailed description of example embodiments, which is to be taken in conjunction with the appended drawings, in which:

FIG. 1A shows a SMF 1 according to an example embodiment,

FIG. 1B shows a procedure carried out by the SMF 1 according to the example embodiment,

FIG. 2A shows an IPUPS 2 according to an example embodiment,

FIG. 2B shows a procedure carried out by the IPUPS 2 according to the example embodiment,

FIG. 3A shows a V-EASDF 3 according to an example embodiment,

FIG. 3B shows a procedure carried out by the V-EASDF 3 according to the example embodiment,

FIG. 4 shows an architecture according to option 1 according to an example embodiment,

FIG. 5 shows an architecture according to option 2 according to an example embodiment,

FIG. 6 (reflecting FIG. 4.2.4-9 of TS 23.501) shows a roaming 5G system architecture—home routed scenario in service based interface representation, and

FIG. 7 shows a roaming 5G system architecture based on FIG. 6, in which a connection between V-EASDF and H-DNS is added for illustrating the problem underlying the present application.

### DETAILED DESCRIPTION OF EXAMPLE EMBODIMENTS

In the following, description will be made to example embodiments. It is to be understood, however, that the description is given by way of example only, and that the described example embodiments are by no means to be understood as limiting the present invention thereto.

Before describing example embodiment, in the following, problems of the prior art are discussed in some more detail.

As mentioned above, some example embodiments aim to overcome a problem, which may occur in a roaming scenario in connection with edge computing.

Up to R17, traffic on a HR (roaming) PDU Session is sent between VPLMN and HPLMN over a N9 inter PLMN interface that is meant to terminate on an UPF with so-called IPUPS capability at each of the VPLMN and HPLMN; this interface relies on a GTP-u tunnel per PDU Session and is the same than UPF-UPF interface within a PLMN apart from the fact that it is terminated by an UPF that supports dedicated security features the so-called IPUPS capability.

In R18, edge computing may be supported on such HR PDU Sessions where:

1. For some FQDN ranges, thus for some applications, (supported by the VPLMN and authorized by the HPLMN), the UE exchanges traffic with EAS (Edge Application Servers) at a N6 interface of the VPLMN (this is a new 3GPP feature for R18). This corresponds to a new capability of traffic offload at the VPLMN that 3GPP is going to specify.

2. For the rest of FQDN ranges, thus for the rest of traffic, the UE exchanges traffic with EAS (Edge Application Servers) at a N6 interface of the HPLMN (this traffic is thus sent on the N9 inter PLMN interface that is handled by UPF(s) with IPUPS capability at each of the VPLMN and HPLMN as explained above). This is traffic forwarding on a HR PDU Session as was defined before R18.

Some example embodiments refer to a step that has to take place before the UE can exchange traffic with EAS: the step where the UE needs to contact a DNS server to discover the IP address of the EAS it wishes to contact (translation from FQDN to IP address of the EAS) 3GPP is going to define that for PDU Sessions with this R18 capability of traffic offload at the VPLMN, the network DNS resolver called EASDF is reachable at the N6 interface of the VPLMN; each time the UE needs a translation from FQDN to IP address of the EAS, the UE sends a DNS request to the EASDF, here in VPLMN, thus to a V-EASDF.

For FQDN related with R18 capability of traffic offload at the VPLMN (case 1 above) the VPLMN is not meant to know how to translate the FQDN in the DNS request from the UE, thus the V-EASDF needs to forward this request to a DNS resolver/DNS server of the HPLMN. To do so, the V-EASDF needs to reach a DNS resolver/DNS server of the HPLMN that may be located on the N6 private network of the HPLMN. This means user plane communication between an entity (V-EASDF) on the N6 data network of the VPLMN and an entity (DNS resolver/DNS server of the HPLMN) on the N6 data network of the HPLMN.

This raises new security requirements at user plane that have not been considered so far at 3GPP.

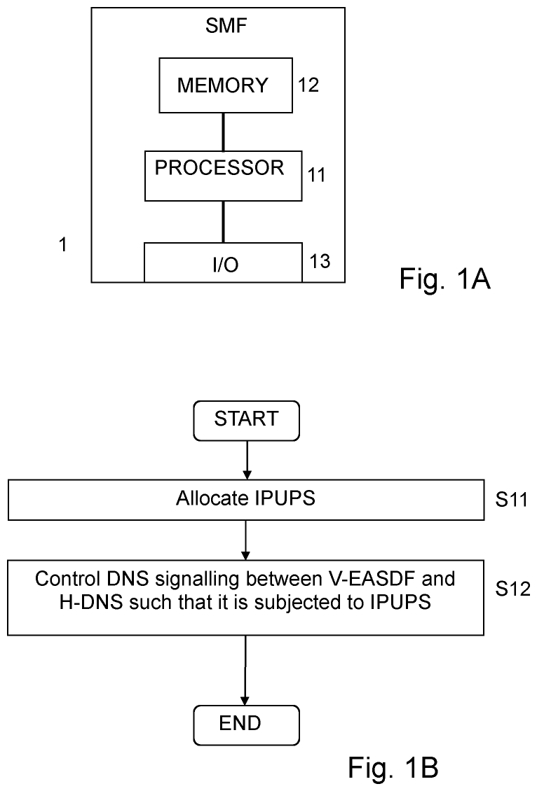

In the following, a general overview of some example embodiments is described by referring to FIGS. 1A, 1B, 2A, 2B, 3A and 3B.

FIG. 1A shows an SMF 1 according to the present example embodiment. The SMF 1 is an example for an apparatus, which could be or be a part of a network control element, which may carry out a service management function or which may act as a service management function, for example. A procedure carried out by the SMF 1 is illustrated in FIG. 1B. The SMF 1 shown in FIG. 1A comprises at least one processor 11 and at least one memory 12 including computer program code. The at least one processor 11, with the at least one memory 12 and the computer program code, is configured to cause the apparatus to perform: allocating a network security function (e.g., IPUPS) between a visited network and a home network of a user equipment (S11 in FIG. 1B), and controlling domain name system related signalling (e.g., DNS signalling) between an edge computing related network element in the visited network (e.g., V-EASDF) and a network element in the home network (e.g., H-DNS or H-EASDF) such that the domain name system related signalling is subjected to the network security function (S12 in FIG. 1B).

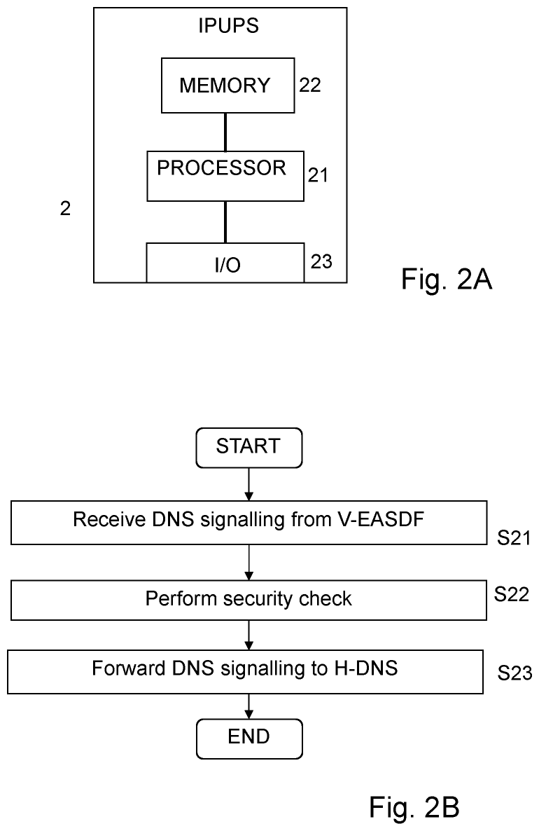

FIG. 2A shows an IPUPS according to the present example embodiment. The IPUPS 2 is an example for an apparatus, which could be or be a part of a network element, which carries out a network security function or which may act as a network security function, for example. A procedure carried out by the IPUPS 2 is illustrated in FIG. 2B. The IPUPS 2 shown in FIG. 2A comprises at least one processor 21 and at least one memory 22 including computer program code. The at least one processor 21, with the at least one memory 22 and the computer program code, is configured to cause the apparatus to perform: receiving domain name system related signalling (e.g., a DNS message) from an edge computing related network element in a visited network (e.g., V-EASDF) (S21 in FIG. 2B), performing a security check on the domain name system related signalling (S22 in FIG. 2B), and forwarding the domain name system related signalling to a network element in the home network (e.g. H-DNS, H-EASDF), in case the security check is positive.

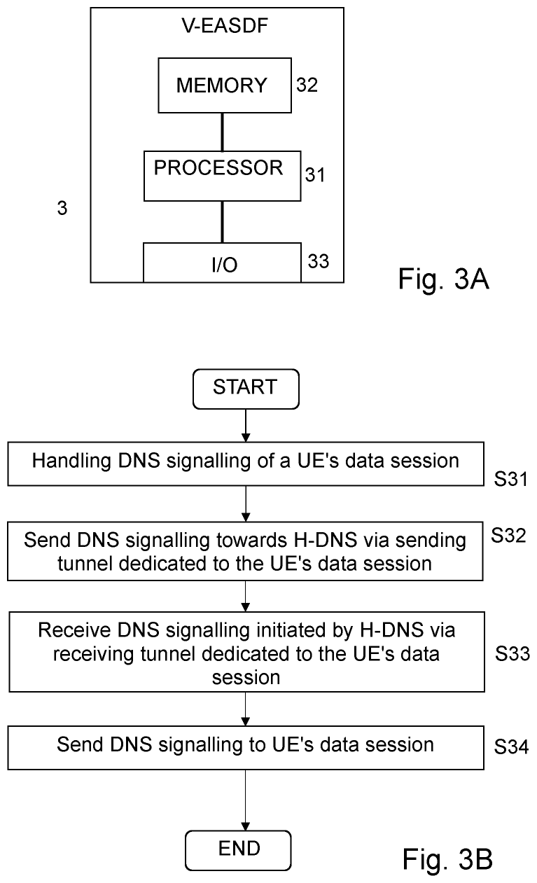

FIG. 3A shows a V-EASDF 3 according to the present example embodiment. The V-EASDF 3 is an example for an apparatus, which could be or be a part of an edge computing related network element, which carries out an edge computing related function or which may act as a edge computing related function (such as an edge application server discovery function (EASDF)), for example. A procedure carried out by the V-EASDF 3 is illustrated in FIG. 3B. The V-EASDF 3 shown in FIG. 3A comprises at least one processor 31 and at least one memory 32 including computer program code. The at least one processor 31, with the at least one memory 32 and the computer program code, is configured to cause the apparatus to perform: handling domain name system related signalling from a user equipment's data session in a visited network of the user equipment (S31 in FIG. 3B), sending corresponding domain name system related signalling towards a network element in the home network (e.g., H-DNS or H-EASDF), in a sending tunnel dedicated to the user equipment's data session (S32 in FIG. 3B), receiving domain name system related signalling initiated by a network element in the home network (e.g., H-DNS or H-EASDF) in a receiving tunnel dedicated to the user equipment's data session (S33 in FIG. 3B), and sending received domain name system related signalling to a user equipment's data session (S34 in FIG. 3B).

On the sending tunnel and/or the receiving tunnel, a network security function (such as the IPUPS) may be provided.

Thus, according to example embodiments, domain name system related signalling such as DNS messages is exchanged between an edge computing related element (such as an EASDF) in a visited network and a network element in the home network (such as a DNS) via a network security function (such as the IPUPS). Hence, safety in a HR roaming scenario is enhanced.

The apparatuses (network elements) 1, 2 and 3 shown in FIGS. 1A, 2A and 3A may comprise more components than described above, and may further comprise I/O units 13, 23, 33, which are capable of transmitting to and receiving from other network elements.

The security check described above, which is performed by the network security function, may be considered to be positive when messages of the DNS signalling (e.g., including GTP-U packets received via the N9 interface) only if they belong to an active session (active PDU Session) and are not malformed.

The network security function may be allocated by inserting the network security function on a path between the edge computing related network element in the visited network (e.g., the V-EASDF) and the network element in the home network (e.g., the H-DNS). Alternatively, the network security function may be allocated by re-using an existing network security function between an access network in the visited network and a data network in the home network.

The SMF 1 may be located in the visited network, and the network security function may be located in the visited network. In this situation, SMF 1 may configure the edge computing related network element in the visited network (e.g., V-EASDF) or the network security function in the visited network (IPUPS) to associate per UE's data session a user plane tunnel (e.g., GTP-U tunnel, but could be another kind of tunnel such as IP in IP, GRE, . . . ) dedicated to the UE's data session and aimed at transporting DNS signalling between the edge computing related network element in the visited network and the network element in the home network (e.g., H-DNS).

Moreover, the user plane tunnel dedicated to the UE's data session and aimed at transporting DNS signalling between the edge computing related network element in the visited network and the network element in the home network may be distinct from the user plane tunnel dedicated to the UE's data session aimed at transporting user plane data between the user plane function in the visited network and the user plane function in the home network.

In the following, the procedures described above are described in some more detail following by referring to some further detailed embodiments.

Therefore, the present invention proposes a procedure/architecture enhancement where also these DNS messages will traverse the IPUPS functionality.

As mentioned above, some example embodiments propose two options for solving the aforementioned problem to protect the V-EASDF by forwarding the DNS traffic towards the H-PLMN via IPUPS.

In option 1, it is suggested to establish a dedicated new GTP tunnel carrying the DNS traffic between V-PLMN and the H-PLMN. In other words, an additional IPUPS functionality is installed on the path between the V-EASDF and the H-DNS.

In option 2 it is suggested to re-use the already existing GTP tunnel between V-PLMN and the H-PLMN for the DNS traffic. In other words, according to option 2, an existing IPUPS functionality on the V-UPF/H-UPF connection is reused by re-routing the messages (and avoiding the direct V-EADSF/H-DNS connectivity)

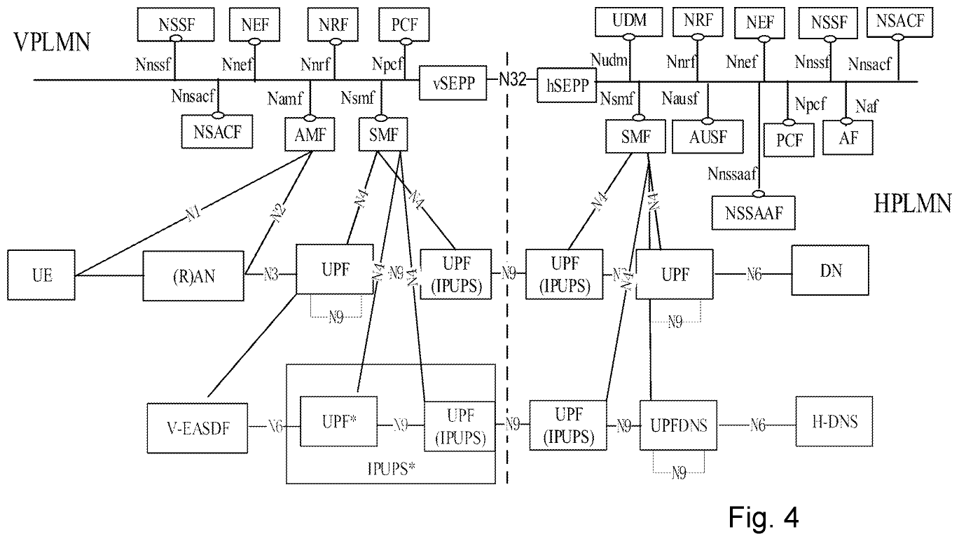

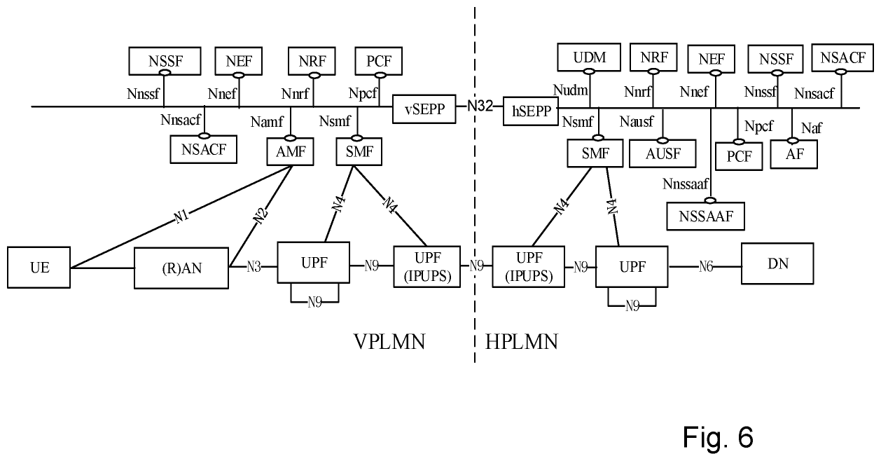

In the following, the architecture according to option 1 is described by referring to FIG. 4, which is based on FIG. 4.2.4-9 of TS 23.501 V17.6.0 (2022-09) (described above in connection with FIG. 6).

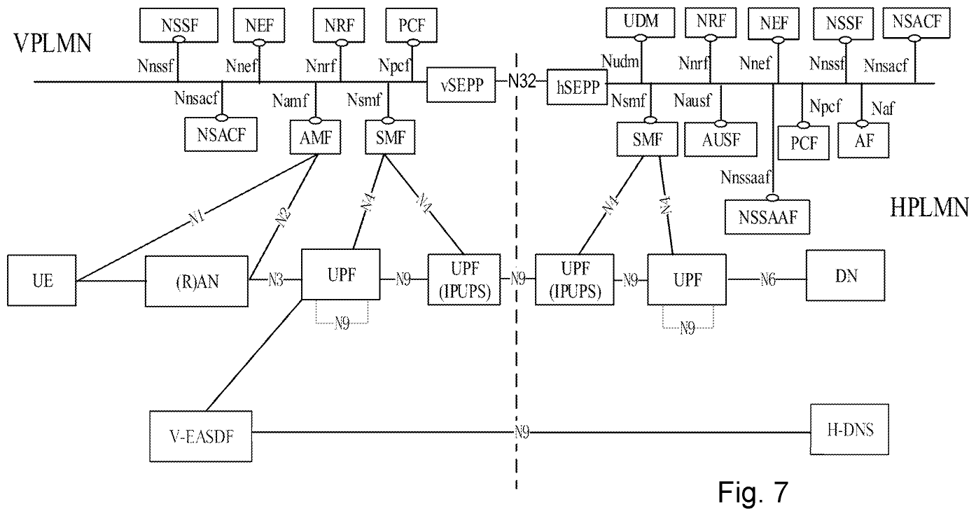

Nevertheless, first, the problem underlying the present application is again described by referring to FIG. 7, which shows a roaming 5G system architecture based on FIG. 6. As shown in FIG. 7, in addition to the architecture shown in FIG. 6, the V-EASDF and the H-DNS are shown. It is noted that the black arrow at the bottom (from V-EADSF to H-DNS) is the direct connectivity currently envisaged in the respective solution of TR 23.700-48, for EADSF selection in HR roaming. This black arrow is not subject to IPUPS, so that according to example embodiments, it is proposed to make also this connection subject to IPUPS. As mentioned above, for this, according to option 1, an additional IPUPS functionality is installed on that path (for that black arrow), as it is shown in FIG. 4. According to option 2, which will be described later, the existing IPUPS functionality on the V-UPF/H-UPF connection is re-used by re-routing the messages (and avoiding the direct V-EADSF/H-DNS connectivity).

Hence, as shown in FIG. 4, according to option 1, it is suggested that, if the V-SMF wants to allocate a V-IPUPS beyond the V-EASDF (at the inter PLMN border of the VPLMN), the V-SMF may do one of following actions 1) insert an V-IPUPS* supporting IPUPS functionality and mediating between N6 to N9, or 2) insert an UPF* (mediating between N6 and N9) and a normal IPUPS or 3) control the V-EASDF to terminate GTP-U layer interface with a normal IPUPS. In any case the V-SMF shall send additionally the downlink Fully Qualified TEID of the V-IPUPS* or V-IPUPS (connected with the V-EASDF) in the PDU session signalling towards the H-SMF such as PDU Session establishment request or PDU Session modification request.

It is noted that, if the V-SMF does not wish to insert an IPUPS for the DNS traffic going through the V-EASDF there may be no need to share the DL IP address of the V-EASDF with the H-SMF/H-PLMN.

The H-SMF receiving that additional downlink FQTEID of the V-IPUPS* in the PDU session establishment request message or PDU session modification request may or may not select its own H-IPUPS_{DNS} and H-UPF_{DNS} or only a H-UPF_{DNS} to reach the H-DNS. The H-UPF_{DNS} is a UPF dedicated to the DNS in the home network, and the H-IPUPS_{DNS} is a IPUPS dedicated to the DNS in the home network.

Anyhow whether H-SMF inserts both IPUPS and H-UPF or only H-UPF, the H-SMF shall instruct the H-IPUPS_{DNS} or the H-UPF_{DNS} to forward DL traffic towards the DL FQTEID of the V-IPUPS*/V-IPUPS and additionally shall send the uplink FQTEID address of the H-IPUPS_{DNS}/H-UPF_{DNS} to the V-SMF in the PDU session establishment response message.

Furthermore, on instruction from the H-SMF, the UPF_{DNS} modifies the source IP address of the DNS queries to an own specific IP address (per N9 inter-PLMN tunnel, separate inner IP address) to forward the DNS queries in a single/common IP in IP tunnel towards the H-DNS, and that it restitutes the destination address back to the EASDF IP address when forwarding the DNS response.

If the H-SMF selects and inserts an UPF performing IP in IP tunnelling as described in the Note 13 in the chapter 6.2.3.2.2 of TS 23.548 between the H-UPF_{DNS} PSA and the H-DNS server and the H-SMF instructs the H-UPF_{DNS} PSA to forward to UPF which applies IP in IP tunnelling to the DNS traffic.

On receipt of the uplink FQTEID address of the H-IPUPS_{DNS}/H-UPF_{DNS} at the V-SMF, the V-SMF instructs the V-IPUPS to forward uplink traffic to the H-IPUPS_{DNS}/H-UPF_{DNS}

It is to be noted that the V-IPUPS* and the V-UPF* is a new deployment of UPF/IPUPS as the new V-UPF* shall mediate between N6 and N9 and vice versa and the new V-IPUPS* shall mediate between N6 and N9 and vice versa.

Alternatively, the solution IP in IP tunnelling as described in ch. 6.2.3.2.2 of TS 23.548 may also be used between PLMNs. In this case, DNS messages between EASDF and DNS Server described in this clause are transferred via this UPF transparently. However, this solution requires additional agreements between PLMNs.

Hence, according to option 1, the following novel features are provided:
Protection of V-EASDF and introduction of IPUPS* or UPF* also for the DNS traffic
Exchange of FQTEIDs of the new IPUPS* or UPF* between V-SMF/V-PLMN and V-SMF/H-PLMN during PDU session establishment and other procedures/messages like Handover and service request and etc.
SMFs to insert IPUPS dedicated for DNS traffic/V-EASDF
SMFs control two sets of IPUPS/UPFs: one for the normal PDU session and one for the DNS traffic
New IPUPS* or UPF* mediating between N6 and N9 interface and vice versa
Alternatively the V-EASDF add the GTP-U layer to the stack to carry the DNS query towards IPUPS and shall be able receive DNS response via the GTP-U stack from the IPUPS

Furthermore, multiple EC URLLC specific services are possible, as will be described in the following.

Namely, the same principle can be generalized to be available also for multiple PSA UPFs providing session breakout for different URLLLC services. See FIGS. 4.3-1 of TS 23.548 illustrating 5GC Connectivity Models for Edge Computing:
one session break out for payload with 5 ms maximum delay across V-PLMN and H-PLMN and
another session break out for payload with 15 ms maximum delay across V-PLMN and H-PLMN and
another session break out for payload with 35 ms maximum delay across V-PLMN and H-PLMN, which may simultaneously exist within one PDU session across the V-PLMN and the H-PLMN.

Therefore, it is suggested to allow a list of FQTEIDS containing the FQTEIDs for each flow/session breakout to be established between V-PLMN and H-PLMN for the corresponding service specific user plane traffic. In this case, each DNS traffic of (URLLC) specific service may be routed via an additional dedicated DNS traffic corresponding to the flow/session break out in question.

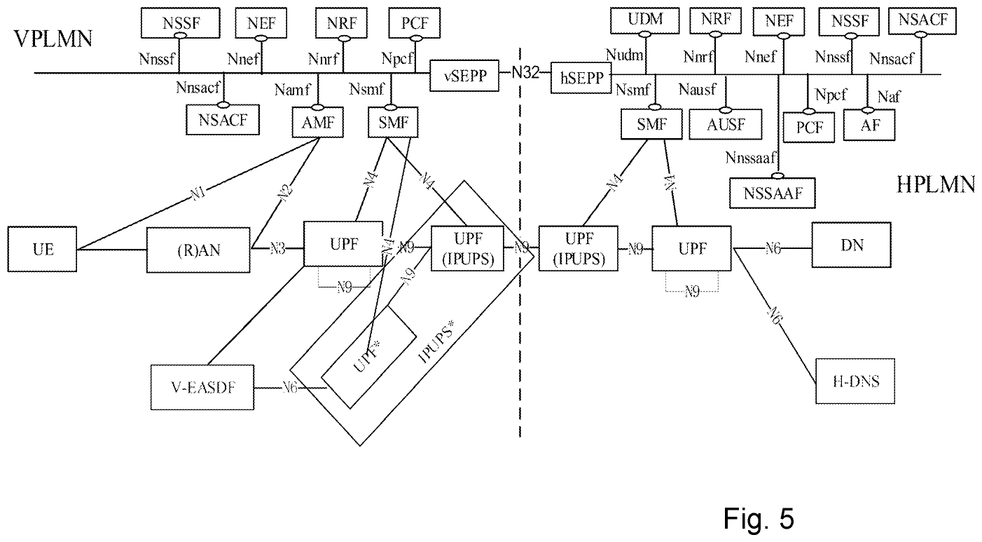

In the following, the architecture according to option 2 is described by referring to FIG. 5, which is also based on FIG. 6 (FIG. 4.2.4-9 of TS 23.501 V17.6.0 (2022-09)) already mentioned above. Thus, FIG. 5 shows a roaming 5G System architecture—home routed roaming scenario in service-based interface representation employing UPF dedicated to IPUPS reusing/augmenting legacy IPUPS for merging and re-using H-UPF PSA for splitting V-EASDF traffic.

Thus, according to option 2, if the V-SMF wants to efficiently re-use the existing V-IPUPS beyond the V-EASDF, the V-SMF shall insert an V-IPUPS* mediating from N6 to N9 and vice versa with some kind of “reverse UL CL UPF functionality” merging/splitting the DNS traffic into/from the existing N9 GTP tunnel or a concatenation of UPF* (mediating from N6 to N9) and IPUPS with some kind of “reverse UL CL UPF functionality” merging/splitting the DNS traffic into/from the existing N9 GTP tunnel and the V-SMF shall sent additionally an indication “split/merge DNS traffic” towards the H-SMF that splitting and merging functionality is required at the H-UPF PSA to differentiate the DNS traffic from other payload. This splitting/merging indication may be the IP address of the V-EASDF issuing the DNS request.

It is noted that existing UL CL UPF functionality was introduced in TS 23.501 in order to specify that at UL CL UPF uplink traffic can be split to different PSA UPF, and downlink traffic sent by different PSA UPF can be merged at the UL CL UPF. However, here the new IPUPS functionality merges uplink traffic and splits down link traffic.

Alternatively, the V-EASDF itself already adds GTP-U layer and sends the DNS Query to the IPUPS* with split/merge functionality and shall accept DNS response carried via the GTP-U layer.

The H-SMF receiving that additional indication “split/merge DNS traffic” in the PDU session establishment request message selects and inserts an UPF performing IP in IP tunnelling as described in the Note 13 in the chapter 6.2.3.2.2 of TS 23548 between the H-UPF PSA and the H-DNS server and the H-SMF instructs the H-UPF PSA to forward to UPF which applies IP in IP tunnelling to the DNS traffic.

On instruction from the H-SMF, the UPF DN s modifies the source IP address of the DNS queries to an own specific IP address (per N9 inter-PLMN tunnel, separate inner IP address) to forward the DNS queries in a single/common IP in IP tunnel towards the H-DNS, and then it restitutes the destination address back to the EASDF IP address when forwarding the DNS response (DL).

It is to be noted that the V-IPUPS* and the V-UPF* is a new deployment of UPF/IPUPS as the new V-UPF* shall mediate between N6 and N9 and vice versa, and the new V-IPUPS* shall mediate between N6 and N9 and vice versa. Furthermore, in this option the V-IPUPS performs splitting/merging of DNS traffic. Similarly, the H-UPF PSA performs splitting/merging of DNS traffic.

Hence, according to option 2, the following new features are provided:
Protection of V-EASDF and introduction of IPUPS* or UPF* also for the DNS traffic
V-SMF to request the V-EASDF and the V-EASDF to report the IP address of the V-EASDF originating the DNS query on behalf of the UE
Exchange of V-EASDF IP originating the DNS query on behalf of the UE via control plane from the V-SMF to the H-SMF during PDU session establishment and whenever the V-EASDF has changed like for instance Handover and service request etc.
V-SMF to insert an UPF* mediating from N6 to N9 and vice versa between V-EASDF and existing V-IPUPS
Alternatively the V-EASDF adds the GTP-U layer to the stack to carry the DNS query towards IPUPS and shall be able receive DNS response via the GTP-U stack from the IPUPS
V-SMF to instruct the V-IPUPS to accept and merge/split DNS traffic into the N9 tunnel towards the H-IPUPS such that the IPUPS becomes a “reverse UL CL UPF IPUPS” i.e. IPUPS**
H-SMF to receive the IP address of the V-EASDF originating the DNS query
H-SMF to instruct the H-UPF PSA to split/merge the DNS traffic and other payload based on the normal IP address of the UE and the newly defined IP address of V-EADSF
SMF to instruct the H-UPF PSA to forward DNS traffic UPF performing IP in IP tunnelling between H-UPF PSA and H-DNS

Furthermore, similar as in case of option 1, multiple EC URLLC specific services are possible, as will be described in the following.

Namely, the same principle can be generalized to be available also for multiple PSA UPFs providing session breakout for different URLLLC services. See FIGS. 4.3-1 of TS 23.548 illustrating 5GC Connectivity Models for Edge Computing:
one session break out for payload with 5 ms maximum delay across V-PLMN and H-PLMN and another session break out for payload with 15 ms maximum delay across V-PLMN and H-PLMN and another session break out for payload with 35 ms maximum delay across V-PLMN and H-PLMN which may simultaneously exist within one PDU session across the V-PLMN and H-PLMN.

Therefore, it is suggested to allow a list of FQTEIDs containing the FQTEIDs for each flow/session breakout to be established between V-PLMN and H-PLMN for the corresponding service specific user plane traffic. In this case, each DNS traffic of (URLLC) specific service may be routed via the associated user flow path as described for one single flow/session breakout path above. This means that with the option 2 there might be the need for each differentiated URLLC traffic to individually signal an associated split/merge indication from V-PLMN to H-PLMN to differentiate possibly different DNS traffic from each URLLC payload traffic. Or to differentiate the different DNS traffic from the plain payload if transmitted via the main PDU session part.

The above-described example embodiments are only examples and may be modified.

For example, the H-DNS is just an example for a network element in the home network, another example would be the H-EASDF.

According to a first aspect of some example embodiments, an apparatus is provided, in a network control element (such as an SMF), comprising: at least one processor and at least one memory including computer program code, the at least one memory and the computer program code configured to, with the at least one processor, cause the apparatus at least to perform: allocating a network security function (e.g., an IPUPS) between a visited network and a home network of a user equipment, and controlling domain name system related signalling between an edge computing related network element in the visited network (e.g., a V-EASDF) and a network element in the home network (e.g. H-DNS) such that the domain name system related signalling is subjected to the network security function.

The above first aspect may be modified as follows:

The at least one memory and the computer program code may be configured to, with the at least one processor, cause the apparatus to further perform: allocating the network security function by inserting a network security function on a path between the edge computing related network element in the visited network and the network element in the home network.

The network control element (e.g., SMF) may be located in the visited network, and the network security function may be located in the visited network.

The at least one memory and the computer program code may be configured to, with the at least one processor, cause the apparatus to further perform: configuring at least one of the edge computing related network element in the visited network or the network security function in the visited network to associate per user equipment's data session a user plane tunnel dedicated to the user equipment's data session and aimed at transporting domain name system related signalling between the edge computing related network element in the visited network and the network element in the home network.

The user plane tunnel dedicated to the user equipment's data session and aimed at transporting domain name system related signalling between the edge computing related network element in the visited network and the network element in the home network may be distinct from the user plane tunnel dedicated to the user equipment's data session aimed at transporting user plane data between the user plane function in the visited network and the user plane function in the home network.

The at least one memory and the computer program code may be configured to, with the at least one processor, cause the apparatus to further perform: sending addressing information (e.g., FQTEID) of the network security function located in the visited network to a network control element in the home network (e.g., H-SMF), per user equipment's data session, for the transport of domain name system related signalling from the network element in the home network to the edge computing related network element in the visited network.

The at least one memory and the computer program code may be configured to, with the at least one processor, cause the apparatus to further perform: sending the addressing information (e.g., FQTEID) of the network security function located in the visited network to a network control element in the home network (e.g. H-SMF) during a session establishment or a session mobility procedure.

The network control element may be located in the home network and the network security function may be located in the home network.

The at least one memory and the computer program code may be configured to, with the at least one processor, cause the apparatus to further perform: inserting the network security function located in the home network (e.g., a H-IPUPS) and performing at least one of: configuring the network security function located in the home network with the addressing information of the network security function located in the visited network per User's equipment data session aiming at transporting at least domain name system related signalling from the network element in the home network to the edge computing related network element in the visited network; and/or providing its addressing information to a network control element located in the visited network (e.g., V-SMF) during a session establishment or a session mobility procedure.

The at least one memory and the computer program code may be configured to, with the at least one processor, cause the apparatus to further perform: sending of the addressing information (e.g., FQTEID) of the network security function located in the home network to a network control element in the visited network (e.g., V-SMF) during a session establishment or a session mobility procedure.

The at least one memory and the computer program code may be configured to, with the at least one processor, cause the apparatus to further perform: requesting a user plane function (e.g., UPF) in the home network (e.g., H-PLMN) to allocate an IP address per user equipment's data session and to perform network address translation from the source address of uplink traffic towards this allocated IP address when forwarding domain name system signalling received from the edge computing related network element in the visited network (e.g., V-EASDF) towards the network element in the home network (e.g., H-DNS); and requesting the user plane function in the home network (H-PLMN) to modify the destination IP address back to the original source address of uplink traffic when forwarding domain name system related signalling received from the network element in the home network.

The at least one memory and the computer program code may be configured to, with the at least one processor, cause the apparatus to further perform: allocating the network security function by using an existing network security function for the same user equipment's data session.

The existing network security function may be arranged for the same user equipment's data session between an access network (e.g. (R)AN) in the visited network and a data network in the home network.

The existing network security function may be arranged for the same user equipment's data session between a user plane function connected to the access network in the visited network and a user plane function connected to the data network in the home network.

The at least one memory and the computer program code may be configured to, with the at least one processor, cause the apparatus to further perform: re-routing the domain name system related signalling between the edge computing related network element in the visited network (e.g., V-EASDF) and the network element in the home network (e.g., H-DNS) via the existing network security function for the same user equipment's data session.

The network control element may be a network control element in the visited network (e.g., V-SMF), and the at least one memory and the computer program code may be configured to, with the at least one processor, cause the apparatus to further perform: inserting a network security function in the visited network between the edge computing related network element in the visited network (e.g., V-EASDF) and the existing network security function in the home network.

The at least one memory and the computer program code may be configured to, with the at least one processor, cause the apparatus to further perform: instructing the network security function in the visited network to merge uplink domain name system related signalling into, or split downlink domain name system related signalling from, a user plane connection (e.g., an N9 tunnel) to/from the existing network security function in the home network.

The network control element may be a network control element in the home network (e.g., H-SMF), and the at least one memory and the computer program code may be configured to, with the at least one processor, cause the apparatus to further perform: instructing a user plane network function (e.g., UPF DN s) in the home network connected to the existing network security function in the home network to split domain name system related signalling from, or merge downlink domain name system related signalling into a connection (e.g., an N9 tunnel) to the network security function in the visited network.

The at least one memory and the computer program code may be configured to, with the at least one processor, cause the apparatus to further perform: receiving at least one of: an indication from the network control element in the visited network that uplink user plane traffic needs to be split by the user plane function in the home network into user plane data and domain name system related signalling; and/or the IP address of the edge computing related network element in the visited network (e.g., V-EASDF), also serving as an indication that user plane traffic originated from this address needs to be split by the user plane function in the home network into user plane data and domain name system related signalling.

The at least one memory and the computer program code may be configured to, with the at least one processor, cause the apparatus to further perform: requesting a user plane function in the home network (e.g., H-PLMN) to allocate an IP address per user equipment's data session and to perform network address translation from the source address of uplink traffic towards this allocated IP address when forwarding domain name system signalling received from the edge computing related network element in the visited network towards the network element in the home network; and requesting the user plane function in the home network to modify the destination IP address back to the original source address of uplink traffic when forwarding domain name system related signalling received from the network element in the home network.

The at least one memory and the computer program code may be configured to, with the at least one processor, cause the apparatus to further perform: controlling the edge computing related network element in the visited network (e.g., V-EASDF) to send and receive domain name system signalling via GPRS Tunnelling Protocol user plane (e.g., GTP-U) layers to/from the network security function.

According to a second aspect of some example embodiments, an apparatus is provided, in a network element (e.g., IPUPS), comprising: at least one processor and at least one memory including computer program code, the at least one memory and the computer program code configured to, with the at least one processor, cause the apparatus at least to perform: receiving domain name system related signalling from an edge computing related network element in a visited network (e.g., V-EASDF), performing a security check on the domain name system related signalling, and forwarding the domain name system related signalling towards a network element in the home network (e.g., H-DNS), in case the security check is positive.

The second aspect may be modified as follows:

The network security function may be inserted on a path between the edge computing related network element in the visited network and the related network element in the home network.

The network security function may be an existing network security function, which is arranged between an access network (e.g., (R)AN)) in the visited network and a data network in the home network.

The existing network security function may be arranged between a user plane function connected to the access network in the visited network and a user plane function connected to the data network in the home network.

The network security function may be inserted in the visited network between the edge computing related network element in the visited network (e.g., V-EASDF) and an existing network security function in the home network.

The at least one memory and the computer program code may be configured to, with the at least one processor, cause the apparatus to further perform: splitting or merging domain name system related signalling into a connection (e.g., N9 tunnel) to the existing network security function in the home network.

According to a third aspect of example embodiments, an apparatus is provided, in an edge computing related network element (e.g., V EASDF), comprising: at least one processor and at least one memory including computer program code, the at least one memory and the computer program code configured to, with the at least one processor, cause the apparatus at least to perform: handling domain name system signalling from an User equipment's data session in a visited network of the user equipment, sending corresponding domain name system related signalling towards a network element in the home network (e.g., H-DNS), in a sending tunnel dedicated to the user equipment's data session, receiving domain name system related signalling initiated by a network element in the home network in a receiving tunnel dedicated to the User equipment's data session, and sending received domain name system related signalling to a user equipment's data session.

The third aspect may be modified as follows:

The at least one memory and the computer program code may be configured to, with the at least one processor, cause the apparatus to further perform: negotiating parameters of the receiving tunnel dedicated to the User equipment's data session and aimed at transporting at least signalling from the network element in the home network with a session management function in the visited network (e.g., V-SMF).

The at least one memory and the computer program code may be configured to, with the at least one processor, cause the apparatus to further perform: sending and receiving domain name system related signalling via GPRS Tunnelling Protocol user plane (e.g., GTP-U) layers to/from a network security function (e.g., IPUPS) provided on the sending tunnel and the receiving tunnel.

According to a fourth aspect of some example embodiments, a method is provided, for use in a network control element (e.g., SMF), the method comprising: allocating a network security function (e.g., an IPUPS) between a visited network and a home network of a user equipment, and controlling domain name system related signalling between an edge computing related network element in the visited network (e.g., a V-EASDF) and a network element in the home network (e.g. H-DNS) such that the domain name system related signalling is subjected to the network security function.

The above fourth aspect may be modified as follows:

The method may further comprise: allocating the network security function by inserting a network security function on a path between the edge computing related network element in the visited network and the network element in the home network.

The network control element (e.g., SMF) may be located in the visited network, and the network security function may be located in the visited network.

The method may further comprise: configuring at least one of the edge computing related network element in the visited network or the network security function in the visited network to associate per user equipment's data session a user plane tunnel dedicated to the user equipment's data session and aimed at transporting domain name system related signalling between the edge computing related network element in the visited network and the network element in the home network.

The user plane tunnel dedicated to the user equipment's data session and aimed at transporting domain name system related signalling between the edge computing related network element in the visited network and the network element in the home network may be distinct from the user plane tunnel dedicated to the user equipment's data session aimed at transporting user plane data between the user plane function in the visited network and the user plane function in the home network.

The method may further comprise: sending addressing information (e.g., FQTEID) of the network security function located in the visited network to a network control element in the home network (e.g., H-SMF), per user equipment's data session, for the transport of domain name system related signalling from the network element in the home network to the edge computing related network element in the visited network.

The method may further comprise: sending the addressing information (e.g., FQTEID) of the network security function located in the visited network to a network control element in the home network (e.g. H-SMF) during a session establishment or a session mobility procedure.

The network control element may be located in the home network and the network security function may be located in the home network.

The method may further comprise: inserting the network security function located in the home network (e.g., a H-IPUPS) and performing at least one of: configuring the network security function located in the home network with the addressing information of the network security function located in the visited network per User's equipment data session aiming at transporting at least domain name system related signalling from the network element in the home network to the edge computing related network element in the visited network; and/or providing its addressing information to a network control element located in the visited network (e.g., V-SMF) during a session establishment or a session mobility procedure.

The method may further comprise: sending of the addressing information (e.g., FQTEID) of the network security function located in the home network to a network control element in the visited network (e.g., V-SMF) during a session establishment or a session mobility procedure.

The method may further comprise: requesting a user plane function (e.g., UPF) in the home network (e.g., H-PLMN) to allocate an IP address per user equipment's data session and to perform network address translation from the source address of uplink traffic towards this allocated IP address when forwarding domain name system signalling received from the edge computing related network element in the visited network (e.g., V-EASDF) towards the network element in the home network (e.g., H-DNS); and requesting the user plane function in the home network (H-PLMN) to modify the destination IP address back to the original source address of uplink traffic when forwarding domain name system related signalling received from the network element in the home network.

The method may further comprise: allocating the network security function by using an existing network security function for the same user equipment's data session.

The existing network security function may be arranged for the same user equipment's data session between an access network (e.g. (R)AN) in the visited network and a data network in the home network.

The existing network security function may be arranged for the same user equipment's data session between a user plane function connected to the access network in the visited network and a user plane function connected to the data network in the home network.

The method may further comprise: re-routing the domain name system related signalling between the edge computing related network element in the visited network (e.g., V-EASDF) and the network element in the home network (e.g., H-DNS) via the existing network security function for the same user equipment's data session.

The network control element may be a network control element in the visited network (e.g., V-SMF), and the method may further comprise: inserting a network security function in the visited network between the edge computing related network element in the visited network (e.g., V-EASDF) and the existing network security function in the home network.

The method may further comprise: instructing the network security function in the visited network to merge uplink domain name system related signalling into, or split downlink domain name system related signalling from, a user plane connection (e.g., an N9 tunnel) to/from the existing network security function in the home network.

The network control element may be a network control element in the home network (e.g., H-SMF), and the method may further comprise: instructing a user plane network function (e.g., UPF_{DNS}) in the home network connected to the existing network security function in the home network to split domain name system related signalling from, or merge downlink domain name system related signalling into a connection (e.g., an N9 tunnel) to the network security function in the visited network.

The method may further comprise: receiving at least one of: an indication from the network control element in the visited network that uplink user plane traffic needs to be split by the user plane function in the home network into user plane data and domain name system related signalling; and/or the IP address of the edge computing related network element in the visited network (e.g., V-EASDF), also serving as an indication that user plane traffic originated from this address needs to be split by the user plane function in the home network into user plane data and domain name system related signalling.

The method may further comprise: requesting a user plane function in the home network (e.g., H-PLMN) to allocate an IP address per user equipment's data session and to perform network address translation from the source address of uplink traffic towards this allocated IP address when forwarding domain name system signalling received from the edge computing related network element in the visited network towards the network element in the home network; and requesting the user plane function in the home network to modify the destination IP address back to the original source address of uplink traffic when forwarding domain name system related signalling received from the network element in the home network.

The method may further comprise: controlling the edge computing related network element in the visited network (e.g., V-EASDF) to send and receive domain name system signalling via GPRS Tunnelling Protocol user plane (e.g., GTP-U) layers to/from the network security function.

According to a fifth aspect of some example embodiments, a method is provided, for use in a network element (e.g., IPUPS), the method comprising: receiving domain name system related signalling from an edge computing related network element in a visited network (e.g., V-EASDF), performing a security check on the domain name system related signalling, and forwarding the domain name system related signalling towards a network element in the home network (e.g., H-DNS), in case the security check is positive.

The fifth aspect may be modified as follows:

The network security function may be inserted on a path between the edge computing related network element in the visited network and the related network element in the home network.

The network security function may be an existing network security function, which is arranged between an access network (e.g., (R)AN)) in the visited network and a data network in the home network.

The existing network security function may be arranged between a user plane function connected to the access network in the visited network and a user plane function connected to the data network in the home network.

The network security function may be inserted in the visited network between the edge computing related network element in the visited network (e.g., V-EASDF) and an existing network security function in the home network.

The method may further comprise: splitting or merging domain name system related signalling into a connection (e.g., N9 tunnel) to the existing network security function in the home network.

According to a sixth aspect of example embodiments, a method is provided, for use in an edge computing related network element (e.g., V EASDF), the method comprising: handling domain name system signalling from an User equipment's data session in a visited network of the user equipment, sending corresponding domain name system related signalling towards a network element in the home network (e.g., H-DNS), in a sending tunnel dedicated to the user equipment's data session, receiving domain name system related signalling initiated by a network element in the home network in a receiving tunnel dedicated to the User equipment's data session, and sending received domain name system related signalling to a user equipment's data session.

The sixth aspect may be modified as follows:

The method may further comprise: negotiating parameters of the receiving tunnel dedicated to the User equipment's data session and aimed at transporting at least signalling from the network element in the home network with a session management function in the visited network (e.g., V-SMF).

The method may further comprise: sending and receiving domain name system related signalling via GPRS Tunnelling Protocol user plane (e.g., GTP-U) layers to/from a network security function (e.g., IPUPS) provided on the sending tunnel and the receiving tunnel.

According to a seventh aspect of some example embodiments, an apparatus is provided, which comprises means for allocating a network security function (e.g., an IPUPS) between a visited network and a home network of a user equipment, and means for controlling domain name system related signalling between an edge computing related network element in the visited network (e.g., a V-EASDF) and a network element in the home network (e.g. H-DNS) such that the domain name system related signalling is subjected to the network security function.

According to an eighth aspect of some example embodiments, an apparatus is provided, which comprises means for receiving domain name system related signalling from an edge computing related network element in a visited network (e.g., V-EASDF), means for performing a security check on the domain name system related signalling, and means for forwarding the domain name system related signalling towards a network element in the home network (e.g., H-DNS), in case the security check is positive.

According to a ninth aspect of example embodiments, an apparatus is provided, which comprises means for handling domain name system signalling from an User equipment's data session in a visited network of the user equipment, means for sending corresponding domain name system related signalling towards a network element in the home network (e.g., H-DNS), in a sending tunnel dedicated to the user equipment's data session, means for receiving domain name system related signalling initiated by a network element in the home network in a receiving tunnel dedicated to the User equipment's data session, and means for sending received domain name system related signalling to a user equipment's data session.

According to all aspects and modifications described above, the network element in the home network may be a domain name related network element (e.g., H-DNS) or an edge computing related network element in the home network (e.g., H-EASDF).

According to a tenth aspect of example embodiments, a computer program product is provided which comprises code means for performing a method according to any one of the first to third aspects and/or their modifications when run on a processing means or module. The computer program product may be embodied on a computer-readable medium, and/or the computer program product may be directly loadable into the internal memory of the computer and/or transmittable via a network by means of at least one of upload, download and push procedures.

Names of network elements, protocols, and methods are based on current standards. In other versions or other technologies, the names of these network elements and/or protocols and/or methods may be different, as long as they provide a corresponding functionality.

In general, the example embodiments may be implemented by computer software stored in the memory (memory resources, memory circuitry) 12, 22, 32 and executable by the processor (processing resources, processing circuitry) 11, 21, 31 or by hardware, or by a combination of software and/or firmware and hardware.

As used in this application, the term “circuitry” refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory (memory resources, memory circuitry) 12, 22, 32 may be of any type suitable to the local technical environment and may be implemented using any suitable data storage technology, such as semiconductor based memory devices, magnetic memory devices and systems, optical memory devices and systems, fixed memory and removable memory, and non-transitory computer-readable media. The processor (processing resources, processing circuitry) 11, 21, 31 may be of any type suitable to the local technical environment, and may include one or more of general purpose computers, special purpose computers, microprocessors, digital signal processors (DSPs) and processors based on a multi core processor architecture, as non-limiting examples.

It is to be understood that the above description is illustrative of the invention and is not to be construed as limiting the invention. Various modifications and applications may occur to those skilled in the art without departing from the true spirit and scope of the invention as defined by the appended claims.

1. A method for use in a network control element, the method comprising:
allocating a network security function between a visited network and a home network of a user equipment, and
controlling domain name system related signalling between an edge computing related network element in the visited network and a network element in the home network such that the domain name system related signalling is subjected to the network security function.

2. The method according to claim 1, further comprising:
allocating the network security function by inserting a network security function on a path between the edge computing related network element in the visited network and the network element in the home network.

3. The method according to claim 2, wherein the network control element is located in the visited network, and the network security function is located in the visited network.

4. The method according to claim 2, further comprising:
configuring at least one of the edge computing related network element in the visited network or the network security function in the visited network to associate per user equipment's data session a user plane tunnel dedicated to the user equipment's data session and aimed at transporting domain name system related signalling between the edge computing related network element in the visited network and the network element in the home network.

5. The method according to claim 4, wherein the user plane tunnel dedicated to the user equipment's data session and aimed at transporting domain name system related signalling between the edge computing related network element in the visited network and the network element in the home network is distinct from the user plane tunnel dedicated to the user equipment's data session aimed at transporting user plane data between the user plane function in the visited network and the user plane function in the home network.

6. The method according to claim 3, further comprising:
sending addressing information of the network security function located in the visited network to a network control element in the home network, per user equipment's data session, for the transport of domain name system related signalling from the network element in the home network to the edge computing related network element in the visited network.

7. The method according to claim 2, wherein the network control element is located in the home network and the network security function is located in the home network.

8. The method according to claim 7, further comprising:
inserting the network security function located in the home network and performing at least one of:
configuring the network security function located in the home network with the addressing information of the network security function located in the visited network per User's equipment data session aiming at transporting at least domain name system related signalling from the network element in the home network to the edge computing related network element in the visited network and/or
providing its addressing information to a network control element located in the visited network during a session establishment or a session mobility procedure.

9. The method according to claim 8, further comprising:
requesting a user plane function in the home network to allocate an IP address per User equipment's data session and to perform network address translation from the source address of uplink traffic towards this allocated IP address when forwarding domain name system signalling received from the edge computing related network element in the visited network towards the network element in the home network; and
requesting the user plane function in the home network to modify the destination IP address back to the original source address of uplink traffic when forwarding domain name system related signalling received from the network element in the home network.

10. The method according to claim 1, wherein the at least one memory and the computer program code are configured to, with the at least one processor, cause the apparatus to further perform:
allocating the network security function by using an existing network security function for the same user equipment's data session.

11. The method according to claim 10, further comprising:
re-routing the domain name system related signalling between the edge computing related network element in the visited network and the network element in the home network via the existing network security function for the same user equipment's data session.

12. The method according to claim 10, wherein the network control element is a network control element in the visited network, and the method further comprises:
inserting a network security function in the visited network between the edge computing related network element in the visited network and the existing network security function in the home network.

13. The method according to claim 12, further comprising:
instructing the network security function in the visited network to merge uplink domain name system related signalling into, or split downlink domain name system related signalling from, a user plane connection to/from the existing network security function in the home network.

14. A method for use in a network element, the method comprising:
receiving domain name system related signalling from an edge computing related network element in a visited network,
performing a security check on the domain name system related signalling, and
forwarding the domain name system related signalling towards a network element in the home network, in case the security check is positive.

15. The method according to claim 14, wherein the network security function is inserted on a path between the edge computing related network element in the visited network and the related network element in the home network.

16. The method according to claim 14, wherein the network security function is an existing network security function, which is arranged between an access network in the visited network and a data network in the home network.

17. The method according to claim 14, wherein the network security function is inserted in the visited network between the edge computing related network element in the visited network and an existing network security function in the home network.

18. The method according to claim 17, further comprising:
splitting or merging domain name system related signalling into a connection to the existing network security function in the home network.

19. A method, for use in an edge computing related network element, the method comprising:
handling domain name system signalling from an user equipment's data session in a visited network of the user equipment,
sending corresponding domain name system related signalling towards a network element in the home network, in a sending tunnel dedicated to the user equipment's data session,
receiving domain name system related signalling initiated by a network element in the home network in a receiving tunnel dedicated to the User equipment's data session, and
sending received domain name system related signalling to a user equipment's data session.

20. The method according to claim 19, further comprising:
negotiating parameters of the receiving tunnel dedicated to the User equipment's data session and aimed at transporting at least signalling from the network element in the home network with a session management function in the visited network.
